(19) United States
(12) Patent Application Publication
(10) Pub. No.: US 2008/0290821 A1
(43) Pub. Date: Nov. 27, 2008

(54) Electric Circuit for Individually Controlling Light-Emitting Elements and Optoelectronic Device

(76) Inventors: Benedict Brandt, Munich (DE); Johannes Dietrich, Gilching (DE); Antonio Pascucci, Seefeld (DE); Stefan Lugmair, Munich (DE); Volker Senft, Seefeld (DE); Stefan Wiest, Wessling (DE)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/121,422

(22) Filed: May 15, 2008

(30) Foreign Application Priority Data
May 25, 2007 (EP) 07 010 518.4

(51) Int. Cl. H05B 37/00

(52) U.S. Cl. 315/317

(57) ABSTRACT

The present invention relates to an electric circuit. The electric circuit comprises at least six light-emitting elements and at least three switching networks for individually controlling the light-emitting elements. Each switching network is connected with at least four light-emitting elements. The at least three switching networks are connected with each other by parallel connections of respective two of the at least six light-emitting elements. The respective two light-emitting elements have opposite current blocking directions.

### TECHNICAL FIELD

The present invention relates to an electric circuit for individually controlling light-emitting elements and an optoelectronic device.

### BACKGROUND

For the computer user, it is becoming increasingly important to be able to control and implement two-dimensional and three-dimensional movements or displacements in the computer environment. This is typically achieved using a computer peripheral device. The two- or three-dimensional displacements are detected by the peripheral device and described as a translation (X, Y, Z) and/or a rotation (A, B, C) in space. Furthermore, such displacements may be used to determine a corresponding applied force and/or moment.

Recently developed computer peripheral devices of the above-described type, particularly for the office sector and the entertainment electronics sector, utilize optoelectronic devices to detect and describe displacements in two- or three-dimensional space. Here they function as an input device with which manipulations in up to six degrees-of-freedom can be input, in contrast to a joystick, a mouse or a trackball, which in general only allow input in two degrees-of-freedom. The simple, convenient input of six components, as allowed by a force and/or moment sensor comprising an optoelectronic device, is particularly desirable to control 3D design software and sophisticated computer games.

To this end, the optoelectronic device will typically include one or more measuring cells comprising a position-sensitive detector illuminated by a light-emitting element, such as a light-emitting diode (LED), for measuring displacements in multiple (i.e. up to six) degrees-of-freedom. Examples of such devices are known from United States Patent Application Publication No. 2003/102422 A1 and United States Patent Application Publication No. 2003/103217 A1, and more recently from the co-pending European Patent Application No. 06 007 195.8 and the co-pending International Application Nos. PCT/EP2007/003146 and PCT/EP2007/003149. However, the present invention is not limited to the above mentioned exemplary devices and measuring methods.

Such optoelectronic devices require control circuitry for selectively illuminating the light-emitting elements. However, in such known devices, it has proven to be problematic to provide easy to assemble and reliable control circuitry for the light-emitting elements, in particular, in case the light-emitting elements are located on a displaceable part of the optoelectronic device.

Document EP 0 019 495 A1 concerns an electric circuit comprising a plurality of light emitting diodes which can be selectively illuminated. The electric circuit is preferably employed in the instrument panel of a car.

Document DE 30 08 565 A1 concerns an arrangement for representing information by means of light emitting diodes in particular a LED-display.

Document U.S. Pat. No. 4,321,598 concerns a display system utilizing an array of display cells, each of which includes a pair of oppositely polarized display elements connected in parallel.

U.S. Pat. No. 6,357,893 B1 concerns a flash light comprising a plurality of light emitting diodes, whereby the profile of the projected light of the flash light can be changed. In one embodiment, the batteries of the flash light are connected by means of a spring to a conductor.

Thus, starting from the above prior art, the present invention is based on the object of creating an improved design of an electric circuit for individually controlling light-emitting elements. That is, the electric circuit should be simple to assemble, have a minimal number of parts and should provide more reliable operation. This electric circuit may then be implemented in the creation of an input device for use in the office or entertainment sectors or a force/moment sensor which allows uncomplicated input in up to six degrees-of-freedom.

### SUMMARY

To achieve the above object, the invention provides an electric circuit as defined in claim 1. The electric circuit of the invention could be incorporated in an optoelectronic device or a keyboard for a personal computer.

### Structure and Further Development

According to one aspect, an electric circuit is provided, comprising at least six light-emitting elements and at least three switching networks for individually controlling the light-emitting elements, whereby each switching network is connected with at least four light-emitting elements. In one embodiment, the electric circuit comprises six light-emitting elements and three switching networks. The three switching networks can be selectively switched in a manner so that each light-emitting element can be individually illuminated.

The electric circuit can comprise a delta-connection comprising in each of its branches two respective light-emitting elements, which are connected in parallel between respective two of the at least three switching networks. The three switching networks are respectively connected with the corner nodes of the delta connection. The electric circuit may also comprise a star connection of the light-emitting elements. In this latter embodiment, at least four connections between the six light-emitting elements and the three switching networks would be necessary.

One of the at least three switching networks can be connected with another one of the at least three switching networks by a parallel connection of respective two of the at least six light-emitting elements. In the embodiment comprising six light-emitting elements and three switching networks, the electric circuit arrangement provides direct connections of each switching network with four light-emitting elements.

The respective two light-emitting elements can have opposite current blocking directions. Considering the branch of the electric circuit connecting two switching networks, which comprises a parallel connection of two light-emitting elements, a current from a first switching network to a second switching network can only flow through one of the two light-emitting elements, since the other light-emitting element is blocking. On the other hand, a current from the second switching network to the first switching network can only flow through the other one of the two light-emitting elements, whereby the light-emitting element, through which a current flew in the first case, is in this case blocking. However, it is also possible to individually control the two light-emitting elements by means of frequency. Respective band pass filters may be located in series to each light-emitting element.

The light-emitting elements can comprise light-emitting diodes (LED) and/or infrared light-emitting diodes (ILED). One of the advantages of LED-based lighting is its high efficiency, as measured by its light output per unit power input. Moreover, unlike a light bulb, which lights up regardless of the electrical polarity, light-emitting diodes and infrared light-emitting diodes will only light with positive electrical polarity. When the voltage across the p-n junction of the light-emitting diodes/infrared light-emitting diodes is in the correct direction, a significant current flows and the light-emitting diode/infrared light-emitting diode is forward-biased. If the voltage is of the wrong polarity, the light-emitting diodes/infrared light-emitting diodes is reverse biased, whereby only little current flows, and no light is emitted. Light-emitting diodes and infrared light-emitting diodes can be used, since they are providing illumination and current flow in only one direction of flow. However, the present invention is not limited to light-emitting diodes or infrared light-emitting diodes. The light-emitting elements may for example comprise a series connection of any kind of light-emitting element, for example a light bulb, with a diode.

The switching networks are capable of applying a voltage to two in parallel connected light-emitting elements. The switching networks may selectively apply a voltage to a certain branch of the electric circuit connecting two switching networks. This provides individual control of the light-emitting elements.

The voltage between two switching networks can be continuously controlled in order to continuously control the light intensity of the forward-biased light-emitting element. According to this aspect, it is possible to continuously adjust the light intensity of each light-emitting element. Accordingly, each light-emitting element can be continuously tuned from visible light to non-visible light. This adjustment can be controlled dependent on parameters like deterioration of the light-emitting elements over time, or external parameters like exposure of the electric circuit to light. This enables individual adjustment of each light-emitting element dependent on individual operation requirements of the device in which the electric circuit of the present invention is incorporated.

The switching networks are capable of applying a zero voltage to all light-emitting elements. In case the electric circuit is not in operation or in a standby state, energy consumption can be reduced by applying no voltage to the light-emitting elements.

The connection between one of the at least three switching networks and the at least four light-emitting elements can comprise at least one flexible element. The flexible element may be any kind of flexible member, which provides an electrical connection between the switching networks and the four light-emitting elements, however, additionally provides a flexible connection. In case the distance between the switching networks and the four light-emitting elements changes, the flexible element still provides an electrical connection between the switching networks and the four light-emitting elements. In the embodiment of six light-emitting elements and three switching networks, each switching network is connected by one flexible element with the light-emitting elements.

The at least one flexible element is capable of providing an electrical connection between the at least three switching networks and the at least four light-emitting elements and a mechanical connection between a first object and a second object. The at least four light-emitting elements can be located on the first object and the at least three switching networks can be located on the second object. The flexible element provides both an electrical and a mechanical connection between the first and second object. The first object can be displaceable and the second object can be fixed. The mechanical connection can be a resilient bearing of the first object on the second object or vice versa. However, the mechanical connection is not limited to a resilient bearing. The mechanical connection can be any kind of connection between the first and second object, which enables any kind of motion of the first and/or second object.

The connection between one of the at least three switching networks and the at least four light-emitting elements can be a spring element. The spring element may be a coil spring element. The spring element can consist of an electrically conductive material. The spring element provides both mechanical flexibility and an electrical connection between the switching networks and the four light-emitting elements. The spring element can have a spring constant, which provides sufficient extensibility and restoring force of the spring. The spring element can also comprise a series connection of at least two springs.

The at least six light-emitting elements can be capable of being located on a displaceable first object. The at least three switching networks can be capable of being located on a fixed second object. In case of incorporation of the present electric circuit in an optoelectronic device, the at least six light-emitting elements and the switching networks are displaced on two different objects of the optoelectronic device. The second object is fixed relative to a frame of the optoelectronic device. The first object is mounted in spaced relation to the second object and is adapted for movement relative thereto. This displacement of the at least six light-emitting elements and the at least three switching networks enables a compact design of the displaceable first object, which is desirable for an optoelectronic device. Only the necessary elements of the electric circuit, that is the at least six light-emitting elements, are located on the displaceable first object, whereas the circuitry for controlling the light-emitting elements, that is the at least three switching elements, are located on the fixed second object. The flexible elements are located between the first and the second object and provide a connection between the switching networks and the light-emitting elements.

The at least six light-emitting elements can be mounted on a printed circuit board on the first object and the at least three switching networks can be mounted on a printed circuit board on the second object. The switching elements and the light-emitting elements can be electrically connected by wire elements soldered to printed circuit boards. This provides a stable and easy to assemble construction of the electric circuit of the present invention.

The flexible element can provide a resilient connection between the first object and the second object. The flexible element, which according to one embodiment of the present invention may be a spring element, provides both an electrical connection between the switching networks and the light-emitting elements and a mechanical, i.e. a resilient, bearing of the first object in relation to the second object. In the embodiment of six light-emitting elements and three switching networks, three flexible elements provide a resilient bearing of the first object on the second object, whereby an electrical connection is additionally enabled. In case of incorporation of the electric circuit of the present invention in an optoelectronic device, the flexible elements enable displacement of the first object in up to six degrees-of-freedom and accurate measurements of such displacements. By using the flexible element as both electrical connection between switching networks and light-emitting elements and mechanical bearing, additional wiring between the switching networks and the light-emitting elements can be avoided. This provides reduced material costs, simpler assembly and increased operational durability, since each wire may brake during continuous displacement of the distance between the switching networks and the light-emitting elements.

The at least three switching networks can comprise at least two in parallel connected transistors. The transistors may be any kind of transistors, which provide switching functions. Bipolar junction transistors or field effect transistors can for example be employed.

One of the at least two in parallel connected transistors can be capable of providing a connection with a multiplexer and the other one of the at least two in parallel connected transistors can be capable of providing a connection with a microcontroller. The multiplexer provides input signals for the respective transistor. The input signal is adapted to the kind of transistor employed. The switching networks may additionally comprise amplifying circuitry. The microcontroller in connection with the respective transistor may selectively couple the respective circuit node either to ground or to a resistance. The multiplexer and the microcontroller may be incorporated in a single device. For example, a Motorola MC74 HC4052 analogue multiplexer/demultiplexer may be employed.

The at least three switching networks can alternately illuminate only one of the at least six light-emitting elements. In other words, only one light-emitting element is illuminated at any particular time. The illumination may occur periodically so that selective light beams may be generated. In the embodiment of incorporation of the electric circuit in an optoelectronic device, the light beam generated by the light-emitting element can be detected by detectors such as position-sensitive detectors (PSDs), and/or position-sensitive infrared detectors (PSDs).

The electric circuit according to the present invention can be incorporated in an optoelectronic device. The optoelectronic device can comprise a displaceable first object and a fixed second object incorporating an electric circuit comprising at least six light-emitting elements located on the first object, at least three switching networks located on the second object and at least one flexible element located between the first object and the fixed second object, whereas the at least one flexible element provides an electrical connection between at least one light-emitting element and at least one switching network and a mechanical connection between the first object and the second object.

The electric circuit can be incorporated in a keyboard for a computer.

The above description of the present invention will be more fully understood from the following detailed description of particular embodiments of the invention, which is made by way of example with reference to the accompanying drawings.

### BRIEF DESCRIPTION OF THE DRAWINGS

Embodiments of the invention are illustrated in the following figures, in which like features are indicated with like reference symbols and in which:

FIG. 1 shows a circuit diagram of an electric circuit according to a first embodiment of the present invention;

FIG. 2 shows a circuit diagram of an electric circuit according to a second embodiment of the present invention;

FIG. 3 shows a LED illuminating scheme; and

FIG. 4 shows a circuit diagram of an electric circuit according to a third embodiment of the present invention.

### DETAILED DESCRIPTION OF THE EMBODIMENTS

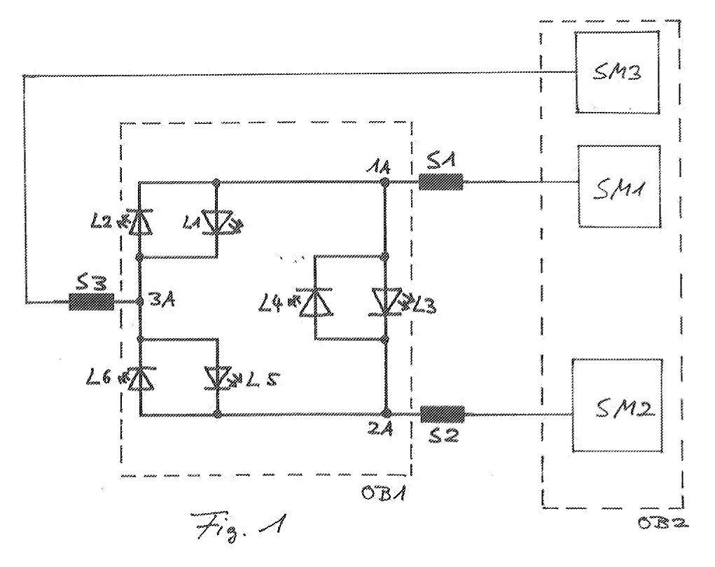

With reference to FIG. 1 of the drawings, the basic components of an electric circuit according to the present invention are illustrated. In this instance, the electric circuit of the invention is designed to be employed in an optoelectronic device which functions as an input device to allow uncomplicated and user-friendly motion input in six degrees-of-freedom in a 3D computer environment. The electric circuit of FIG. 1 comprises three switching networks SM1, SM2, SM3, a delta connection of six light-emitting elements L1, L2, L3, L4, L5, L6 and three spring elements S1, S2 and S3. Light-emitting elements L1, L2, L3, L4, L5 and L6 are located on a first object OB1, which is mounted in a spaced relation to a second fixed object OB2 and which is adapted for movement relative thereto. Switching networks SM1, SM2 and SM3 are located on the second object OB2. Spring elements S1, S2 and S3 are providing electrical connections between light-emitting elements L1, L2, L3, L4, L5, L6 and switching networks SM1, SM2, SM3, and a mechanical connection between the first object OB1 and the second object OB2. Spring elements S1, S2 and S3 are located between the first and second object. By means of spring elements S1, S2 and S3, the first object OB1 and second object OB2 may be moved relative to each other. After movement of the first object, spring elements S1, S2 and S3 can force the displaceable first object OB1 back into its initial position. By moving the displaceable first object OB1, motion input in six degrees-of-freedom in a 3D computer environment can be measured.

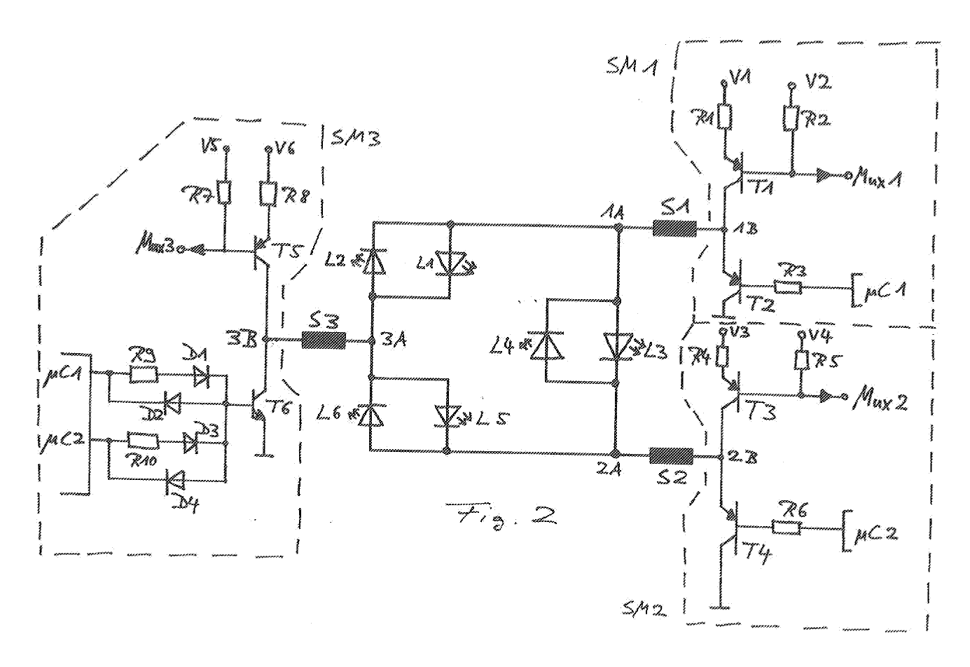

FIG. 2 shows another embodiment of a circuit element according to the present invention. The electric circuit of FIG. 2 comprises three switching networks SM1, SM2, SM3, six light-emitting elements L1, L2, L3, L4, L5, L6 and three spring elements S1, S2 and S3. In the embodiment of FIG. 1, the light-emitting elements are light-emitting diodes (LED). The switching networks SM1, SM2 and SM3 are soldered by wire elements to a printed circuit board (not shown), which is located on an object (not shown), which is fixed relative to a frame of the optoelectronic device (not shown). The light-emitting diodes L1, L2, L3, L4, L5 and L6 are soldered by wire elements to another printed circuit board (not shown), which is located on another object (not shown) of the optoelectronic device, which is mounted in a spaced relation to the fixed object, and which is adapted for movement relative thereto. Any other known technique for connecting the light-emitting diodes and/or the elements of the switching networks with the printed circuit boards may also be used. The branches of the electric circuit between nodes 1A, 2A and 3A and the light-emitting diodes are soldered on the printed circuit board, which is located on the displaceable object.

Spring elements S1, S2 and S3 are located between both printed circuit boards, that is between the fixed object and the displaceable object. Spring elements S1, S2 and S3 provide an electrical connection between the respective nodes, that is spring element S1 provides an electrical connection between nodes 1A and 1B, spring element S2 provides an electrical connection between nodes 2A and 2B and spring element S3 provides an electrical connection between nodes 3A and 3B. In addition to the electrical connections, spring elements S1, S2 and S3 provide a mechanical, that is a resilient, connection between the fixed object and the displaceable object. According to this embodiment of the present invention, only three connections S1, S2 and S3 between the switching networks SM1, SM2, SM3 and the light-emitting diodes L1, L2, L3, L4, L5, L6 exist. However, it is within the scope of the present invention that more than three spring elements S1, S2 and S3 exist. Further spring elements may only deliver resilient functions without providing any electrical connectivity. However, additional electrical connections between the switching networks SM1, SM2, SM3 and the light-emitting diodes L1, L2, L3, L4, L5, L6 may also exist. Such connections may be redundant connections.

The branches directly connecting two respective switching networks comprise parallel connections of two light-emitting diodes. In particular, light-emitting diodes L1 and L2 are in parallel connected between nodes 1A and 3A, light-emitting diodes L3 and L4 are in parallel connected between nodes 1A and 2A and light-emitting diodes L5 and L6 are in parallel connected between nodes 2A and 3A. Moreover, the respective pairs of light-emitting elements have opposite current blocking directions. In particular, light-emitting diodes L1 and L2 have opposite blocking directions, light-emitting diodes L3 and L4 have opposite blocking directions and light-emitting diodes L5 and L6 have opposite blocking directions.

Switching networks SM1 comprise two in parallel-connected PNP bipolar junction transistors T1 and T2. Transistor T1 is with its collector terminal connected to node 1B and with its emitter terminal connected to resistor R1. Resistor R1 can have a resistance of 100Ω. A voltage V1 is applied via resistor R1 to transistor T1. The base of transistor T1 is connected to an output port Mux1 of a multiplexer (not shown). A resistor R2 is connected in parallel to multiplexer port Mux1. Resistor R2 can have a resistance of 100kΩ. The voltage V2 applied to resistor R2 may be the same as voltage V1. Voltages V1 and V2 can both be 5V. Transistor T2 is with its emitter terminal connected to node 1B and with its collector terminal coupled to ground. The base of transistor T2 is connected via resistor R3 to an output port μC1 of a microcontroller (not shown). Resistor R3 can have a resistance of 4.7 kΩ. An analogue multiplexer/demultiplexer MC74HC4052 by Motorola (not shown) provides the multiplexer and microcontroller functions.

Similar to switching networks SM1, switching networks SM2 comprise two parallel-connected bipolar PNP junction transistors T3 and T4. Transistor T3 is with its collector terminal connected to node 2B and with its emitter terminal connected to resistor R4. Resistor R4 can have a resistance of 100Ω. Voltage V3 is applied via resistor R4 to transistor T3. The base of transistor T3 is connected with an output port Mux2 of the multiplexer. In parallel to the branch of output port Mux2 is a resistor R5. Resistor R5 can have a resistance of 100 kΩ. Voltage V4 applied to resistor R5 may be the same as voltage V3. Both voltages V3 and V4 can be 5V. Transistor T4 is connected with its emitter terminal to node 2B and its collector terminal coupled to ground. The base of transistor T4 is connected via resistor R6 to an output port μC2 of the microcontroller. Resistor R6 can have a resistance of 4.7 kΩ.

Switching networks SM3 comprise a parallel connection of a PNP bipolar junction transistor T5 and a NPN bipolar junction transistor T6. Transistor T5 is with its collector terminal connected to node 3B and with its emitter terminal connected to a resistor R8. Resistor R8 can have a resistance of 100Ω. Voltage V6 is applied to resistor R8. The base of transistor T5 is connected to an output port Mux3 of the multiplexer. A resistor R7 is located in parallel to the branch of output port Mux3. Resistor R7 can have a resistance of 100 kΩ. Voltage V5 applied to resistor R7 may be the same as voltage V6. Voltages V5 and V6 can both be 5V. Transistor T6 is with its collector terminal connected to node 3B and with its emitter terminal coupled to ground. The base of transistor T6 is in parallel connected to two output ports μC1 and μC2 of the microcontroller. Each branch from the base of transistor T6 to output ports μC1 and μC2 comprises a further parallel connection of a diode with a diode and a resistance. The first branch consists of a parallel connection of diode D2 with a series connection of diode D1 and resistor R9. The second branch consists of a parallel connection of diode D4 with a series connection of diode D3 and resistor R10. Resistors R9 and R10 can have a resistance of 10 kΩ.

As an example, for illuminating light-emitting diode L1, a voltage is applied to node 1A. Node 3A is coupled to ground and node 2A is coupled to a resistance. In this case, light-emitting diode L1 is forward biased and a current is flowing from node 1A via light-emitting diode L1 to node 3A. Light-emitting diode L2 is reverse biased. No current is flowing via light-emitting diodes L3 and L6. Similar switching may be applied, in order to selectively illuminate the other light-emitting diodes L2, L3, L4, L5 and L6.

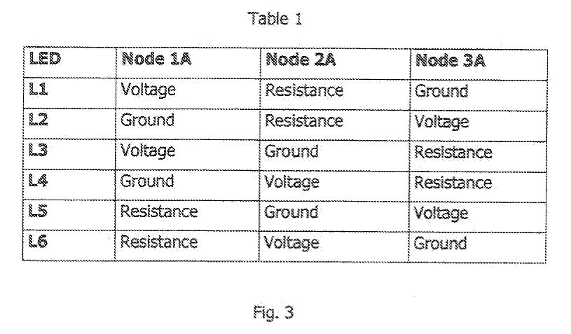

Each light-emitting diode can in accordance with an illuminating scheme stored in the microcontroller be periodically, that is alternately, illuminated. FIG. 3 shows in table 1 a LED illuminating scheme according to one embodiment of the present invention. The first column (from left to right) of table 1 indicates the light-emitting element to be individually illuminated. The second column indicates the required status at node 1A for individually illuminating the respective light-emitting element of column 1. Accordingly, the third column indicates the required status at node 2A for individually illuminating the respective light-emitting element of column 1, and the fourth column indicates the required status at node 3A for individually illuminating the respective light-emitting element of column 1. The three different conditions at the respective node of the delta-connection are voltage, ground and resistance. For example, for individually illuminating light-emitting element L3, a voltage has to be applied to node 1A, node 2A has to be coupled to ground and a resistance has to be applied to node 3A.

The multiplexer output ports Mux1, Mux2 and Mux3 provide output currents, which may be continuously varied. Thereby, the light-intensity of each light-emitting diode may be continuously adjusted, depending on the condition of the light-emitting diodes and the environment. For example, the light-emitting diode may provide less light intensity due to aging so that the voltage has to be increased. Moreover, the external light radiation into the optoelectronic device may be high so that the light intensity of the light-emitting diode has to be adjusted.

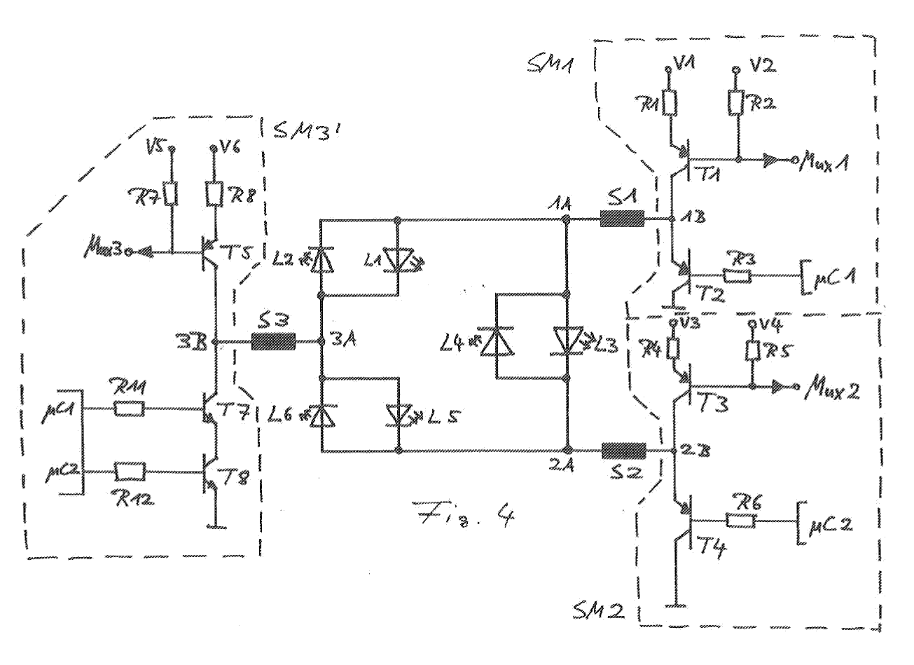

FIG. 4 shows another embodiment of a circuit element according to the present invention. The electric circuit of FIG. 4 is identical to the electric circuit shown in FIG. 2, except the design of switching networks SM3′. The upper part of switching networks SM3′, i.e. the part relating to transistor T5, is identical to switching networks SM3 of FIG. 2. The lower part of switching networks SM3′ in FIG. 4, i.e. the lower part starting from node 3B consists of two PNP bipolar junction transistors T7 and T8. The collector terminal of transistor T7 is connected to node 3B. The emitter terminal of transistor T7 is connected to the collector terminal of transistor T8. The emitter terminal of transistor T8 is coupled to ground. The base of transistor T7 is connected via resistor R11 to output port μC1 of the microcontroller. The base of transistor T8 is connected via resistor R12 to output port μC2 of the microcontroller. Resistors R11 and R12 can have a resistance of 10 kΩ.

1. An electric circuit, comprising:
at least six light-emitting elements; and
at least three switching networks for individually controlling the light-emitting elements, whereby each switching network, is connected with at least four light-emitting elements, characterized in that
the connection between one of the at least three switching networks and the at least four light-emitting elements comprises at least one flexible element, and wherein preferably, the at least one flexible element is capable of providing an electrical connection between the at least three switching networks and the at least four light-emitting elements and a mechanical connection between a first object and a second object.

2. An electric circuit according to claim 1, wherein the electric circuit comprises a delta-connection comprising in each of its branches two respective light-emitting elements, which are connected in parallel between respective two of the at least three switching networks, and/or one of the at least three switching networks is connected with another one of the at least three switching networks by a parallel connection of respective two of the at least six light-emitting elements.

3. An electric circuit according to claim 1, wherein the respective two light-emitting elements have opposite current blocking directions.

4. An electric circuit according to claim 1, wherein the light-emitting elements comprise light-emitting diodes and/or infrared light-emitting diodes.

5. An electric circuit according to claim 1, wherein the switching networks are capable of applying a voltage to two in parallel connected light-emitting elements.

6. An electric circuit according to claim 1, wherein the voltage between two switching networks can be continuously controlled in order to continuously control the light intensity of the forward-biased light-emitting element and/or the switching networks are capable of applying a zero voltage to all light-emitting elements.

7. An electric circuit according to claim 1, wherein the connection between one of the at least three switching networks and the at least four light-emitting elements is a spring element.

8. An electric circuit according to claim 1, wherein the at least six light-emitting elements are capable of being located on a displaceable first object and/or the at least three switching networks are capable of being located on a fixed second object.

9. An electric circuit according to claim 8, wherein the at least six light-emitting elements are mounted on a printed circuit board on the first object and the at least three switching networks are mounted on a printed circuit board on the second object.

10. An electric circuit according to claim 1, wherein the flexible element provides a resilient connection between the first object and the second object.

11. An electric circuit according to claim 1, wherein each of the at least three switching networks comprises at least two in parallel connected transistors and/or one of the at least two in parallel connected transistors is capable of providing a connection with a multiplexer and the other one is capable of providing a connection with a microcontroller.

12. An electric circuit according to claim 1, wherein the at least three switching networks alternately illuminate only one of the at least six light-emitting elements.

13. An optoelectronic device comprising a displaceable first object and a fixed second object incorporating an electric circuit according to claim 1.

14. An optoelectronic device comprising a displaceable first object and a fixed second object incorporating an electric circuit comprising at least six light-emitting elements located on the first object,
at least three switching networks located on the second object and at least one flexible element located between the first object and the second object, whereas the at least one flexible element provides an electrical connection between at least one light-emitting element and at least one switching network and a mechanical connection between the first object and the second object.
